(19) United States
(12) Patent Application Publication
(10) Pub. No.: US 2016/0153368 A1
(43) Pub. Date: Jun. 2, 2016

(54) METHOD FOR PREVENTING ENGINE STALL IN SIGNAL DRIFT OF THROTTLE POSITION SENSOR

(71) Applicant: HYUNDAI MOTOR COMPANY, Seoul (KR)

(72) Inventors: Jung Sup BYUN, Yongin-si (KR); Dong Sun KIM, Seoul (KR)

(21) Appl. No.: 14/688,547

(22) Filed: Apr. 16, 2015

(30) Foreign Application Priority Data
Dec. 2, 2014 (KR) 10-2014-0170689

(51) Int. Cl. F02D 9/08; F02D 41/26

(52) U.S. Cl. CPC F02D 9/08; F02D 41/26

(57) ABSTRACT

A method for preventing an engine stall due to signal drift of a throttle position sensor (TPS) includes determining whether a manifold absolute pressure (MAP) sensor is faulty. If it is determined that the MAP sensor is normal, values sensed by first and second TPSs and the MAP sensor are measured. Whether or not the first and second TPSs are normal is determined by using the values sensed by the first and second TPSs. A normal TPS among the first and second TPSs is determined by comparing the values sensed by the first and second TPSs with the value sensed by the MAP sensor. A throttle opening degree is controlled using the normal TPS.

### CROSS REFERENCE TO RELATED APPLICATION

The present application claims the benefit of priority to Korean Patent Application Number 10-2014-0170689 filed on Dec. 2, 2014, the entire content of which application is incorporated herein for all purposes by this reference.

### TECHNICAL FIELD

The present disclosure relates to a method for preventing an engine stall due to signal drifting of a throttle position sensor (TPS), and more particularly, to a method for preventing an engine stall due to signal drifting of TPSs by controlling a throttle opening degree using a TPS which is determined as normal.

### BACKGROUND

A vehicle is equipped with an electronically controlled throttle device capable of improving drivability by actively reacting to various electric power requirements and by controlling torque of an engine.

The electronically controlled throttle device receives values from throttle position sensors (TPSs) to determine a location of the throttle device to improve safety and signal reliability.

As well known in the art, the values of TPSs are output as a relationship between a voltage and a valve opening degree, and the values of TPS1 and TPS2 are inverted with each other and provided to an engine control unit (ECU).

In this case, the ECU performs a processing procedure based on a preset operation program, converts the value of TPS2 into a relationship between the valve opening degree and the voltage, and uses the relationship, in which a difference ΔTPS occurs between the values of TPS1 and TPS2.

Therefore, a processing scheme differs depending on the characteristics of an engine management system (EMS), but weights (scalers) calculated via repetitive experiments are applied to the values of TPS1 and TPS2, and resulting values are added to obtain a final TPS value.

Typically, the values of TPS1 and TPS2 vary within a defined range, however, when the difference between the values of TPS1 and TPS2 is large due to mechanical or electrical faults, the values of TPS1 and TPS2 may be unreliable.

When the difference between the values of TPS1 and TPS2 exceeds a limit of a correlation, that is, when such a difference exceeds the limit of the correlation due to mechanical or electronic faults, any TPS is diagnosed as an abnormal TPS, and the process enters a limp home mode to induce the engine to be inspected.

When the difference between the values of TPS1 and TPS2 falls within the limit of the correlation, a procedure of determining whether both of the sensors are normal is not performed. In this case, a problem arises in that even if TPS1 is faulty, when the value sensed by TPS1 is continuously used, the engine may stall.

That is, a value sensed by a TPS causes so-called signal drift, that is, an off-idle state signal, due to an increase in a contact resistance of a connector, insertion of impurities, and weakening of a terminal contact force. Then, the off-idle state signal is input to the ECU. Accordingly, although the engine is actually idling, the TPS signal input to the ECU is in the off-idle state.

Therefore, the TPS signal in the off-idle state causes false determination of the ECU, so that an ignition time in the ECU is advanced and false learning of an idle speed actuator (ISA) is caused, thereby suddenly increasing revolutions per minute (RPM) of the engine.

Accordingly, the present disclosure is intended to provide a technology that can prevent the occurrence of a problem where an engine stall occurs because a difference between values of TPS1 and TPS2 does not exceed a limit of a correlation, and then, it is not determined whether any TPS is faulty even if signal drift in a TPS has occurred.

The foregoing is intended merely to aid in the better understanding of the background of the present disclosure, and is not intended to mean that the present disclosure falls within the purview of the related art that is already known to those skilled in the art.

### SUMMARY

The present disclosure has been made keeping in mind the above problems occurring in the prior art, and an aspect of the present inventive concept provides technology that can prevent an engine stall from occurring when a difference between values of TPS1 and TPS2 does not exceed a limit of a correlation, whether or not it is determined any TPS is faulty even if signal drift of a TPS has occurred.

In order to accomplish the above object, a method for preventing engine stalling in signal drift of a throttle position sensor is disclosed.

A method for preventing an engine stall due to signal drift of a throttle position sensor (TPS) according to the present disclosure includes determining whether a manifold absolute pressure (MAP) sensor is faulty. If it is determined that the MAP sensor is normal, values sensed by first and second TPSs and the MAP sensor are measured. Whether or not the first and second TPSs are normal is determined by using the values sensed by the first and second TPSs. A normal TPS is determined by comparing the values sensed by the first and second TPSs with the value sensed by the MAP sensor. A throttle opening degree is controlled using the normal TPS.

The step of determining whether the MAP sensor is faulty may include setting a minimum value and a maximum value of an output value that is output from the MAP sensor. Whether the MAP sensor is normal when the value sensed by the MAP sensor is in a range from the minimum value to the maximum value is determined.

The step of determining whether the first and second TPSs are normal may include determining whether the first and second TPSs are normal when a difference between the values sensed by the first and second TPSs is less than a first reference value.

The throttle opening degree may be controlled using a value calculated by multiplying weighting factors by the sensed values from the first and second TPSs, respectively, at a predetermined ratio. The step of determining the normal TPS may include comparing a difference between the value sensed by the first TPS and the value sensed by the MAP sensor with a difference between the value sensed by the second TPS and the value sensed by the MAP sensor, and then determining a TPS, among the first and second TPSs, having a larger difference to be faulty.

The method may further include comparing a duration of the value sensed by the TPS which is determined to be faulty with a reference time period, and determining whether the duration exceeds the reference time period.

### BRIEF DESCRIPTION OF THE DRAWINGS

The above and other objects, features and advantages of the present disclosure will be more clearly understood from the following detailed description taken in conjunction with the accompanying drawings.

FIG. 1 is a flowchart showing the overall process of a method for preventing an engine stall due to signal drift of a TPS according to the present disclosure.

FIG. 2 is a flowchart in which individual steps of the method for preventing an engine stall due to signal drift of a TPS according to the present disclosure are arranged in detail.

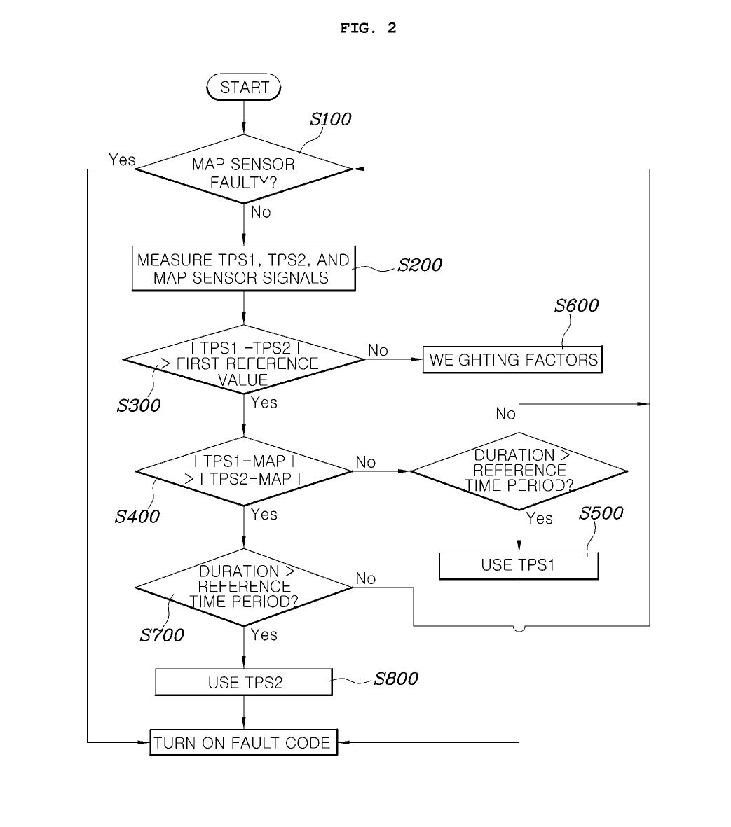

### DETAILED DESCRIPTION

Hereinafter, a method for preventing an engine stall due to signal drift of a Throttle Position Sensor (TPS) according to embodiments of the present disclosure will be described in detail with reference to the attached drawings.

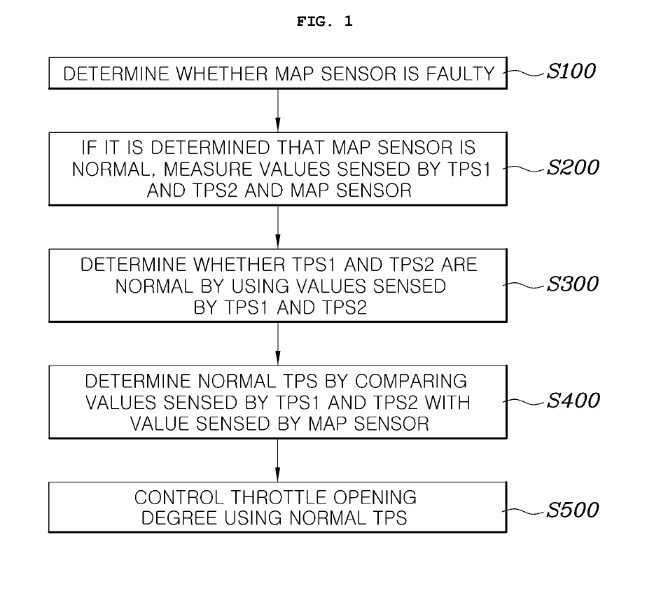

FIG. 1 is a flowchart showing the overall process of a method for preventing an engine stall due to signal drift of a TPS according to the present disclosure. Referring to FIG. 1, a method includes step S100 of determining whether an MAP sensor is faulty. In step S200, if it is determined that the MAP sensor is normal, values sensed by TPS1 and TPS2 and a MAP sensor are measured. Determining whether TPS1 and TPS2 are normal by using the values sensed by TPS1 and TPS2 is performed in step S300. In step S400, a normal TPS is determined by comparing the values sensed by TPS1 and TPS2 with the value sensed by the MAP sensor. Step S500 controls a throttle opening degree using the normal TPS.

That is, according to the present disclosure, when a difference between the values sensed by the TPSs falls within a limit of a correlation, it is not determined whether TPS1 is faulty, and the opening degree of a throttle valve is controlled based on the value sensed by TPS1. On the other hand, an engine stall occurs when the TPS1 is faulty due to so-called signal drift, the values sensed by the TPSs and the MAP sensor are continuously compared with each other, and a normal TPS is determined, and the opening degree of the throttle value is controlled using the normal TPS.

In order to perform the above procedure, it is determined whether the MAP sensor is faulty at step S100.

The control method according to the present disclosure is technically meaningful only when the MAP sensor is normal, and thus, a procedure of determining whether the MAP sensor is normal must precede other procedures.

For this, an engine control unit (ECU) previously stores minimum and maximum values of output values that may be output from the MAP sensor. If it is detected by the ECU that a value sensed by the MAP sensor falls within a range from the minimum value to the maximum value, the MAP sensor is determined to be normal.

In this case, when the value sensed by the MAP sensor falls out of the range from the minimum value to the maximum value, a fault code capable of notifying a driver of the fault of the MAP sensor is turned on.

If it is determined that the MAP sensor is normal, the ECU measures the values sensed by TPS1 and TPS2 and the MAP sensor.

Thereafter, the ECU determines whether TPS1 and TPS2 are normal by using the values sensed by TPS1 and TPS2 at step S300. That is, it is determined whether both of TPS1 and TPS2 are operating normally, or whether any one of TPS1 and TPS2 is faulty.

For this, the ECU sets a first reference value, compares the difference between the values sensed by the TPS1 and TPS2 with the first reference value, determines that both of the TPSs are normal when the difference is less than the first reference value, and also determines that any one of the TPSs is faulty when the difference is greater than the first reference value.

In this case, the first reference value is distinguished from the above-described correlation.

In the past, when both of TPS1 and TPS2 are normal, the opening degree of the throttle valve was controlled using only TPS1, but the present disclosure uses two sensors TPS1 and TPS2 when both of TPS1 and TPS2 are normal, thereby increasing robustness of a vehicle.

In this regard, when the difference between the values sensed by TPS1 and TPS2 is less than the first reference value, it is determined that two TPSs are normal, and then the ECU controls the throttle opening degree using weighting factors multiplied by the respective values sensed by TPS1 and TPS2 at a predetermined ratio at step S600.

For example, as in the case of TPS=TPS1×0.7+TPS2×0.3, pre-stored weighting factors are multiplied by the respective values sensed by the TPS1 and TPS2, and thus, the throttle opening degree is controlled using a resulting TPS value.

Upon comparing the difference between the values sensed by TPS1 and TPS2 with the first reference value, if the difference is greater than the first reference value, it is determined that any one sensor (TPS) is faulty. Such a determination will be described in detail below.

At step S400, a difference between the value sensed by TPS1 and the value sensed by the MAP sensor is compared with a difference between the value sensed by TPS2 and the value sensed by the MAP sensor, and then it is determined that a TPS having a larger difference is faulty.

Since the MAP sensor has already been determined to be normal, the actual air content measured by the MAP sensor may be accurate. Accordingly, respective differences between the value sensed by the MAP sensor and the values sensed by TPS1 and TPS2 are calculated, a TPS having a larger difference may be determined to be faulty, and the other TPS having a smaller difference may be determined to be normal.

In this case, the method for the present disclosure further includes step S700 of comparing the duration of the value sensed by the TPS determined to be faulty with a reference time period, and determining whether the duration exceeds the reference time period. This step determines more precisely whether the corresponding TPS is faulty. Here, if it is determined that the value sensed by the TPS, which is determined by the ECU to be faulty, continues for the reference time period or longer, the TPS is finally determined as the faulty TPS.

Thereafter, the throttle opening degree is controlled using the normal TPS at step S500, and a fault code is turned on so as to notify the driver of the faulty TPS.

As described above, in accordance with the method for preventing engine stalling due to the signal drift of a throttle position sensor (TPS) according to the present invention having the above configuration, there is an advantage in that a faulty TPS is determined by comparing signal values continuously sensed by TPSs and a MAP sensor with each other, and a throttle opening degree is controlled using the signal of a normal TPS, thus maintaining robustness of a vehicle while preventing an engine stall from occurring.

Although specific embodiments of the present inventive concept have been disclosed, those skilled in the art will appreciate that various modifications and changes are possible, without departing from the scope and spirit of the invention as disclosed in the accompanying claims.

What is claimed is:

1. A method for preventing an engine stall due to signal drift of a throttle position sensor (TPS), the method comprising steps of:
determining whether a manifold absolute pressure (MAP) sensor is faulty;
measuring values sensed by first and second TPSs and the MAP sensor if it is determined that the MAP sensor is normal;
determining whether the first and second TPSs are normal by using the values sensed by the first and second TPSs;
determining a normal TPS among the first and second TPSs by comparing the values sensed by the first and second TPSs with the value sensed by the MAP sensor; and
controlling a throttle opening degree using the normal TPS.

2. The method of claim 1, wherein the step of determining whether the MAP sensor is faulty comprises a step of:
setting a minimum value and a maximum value of an output value that is output from the MAP sensor, and determining whether the MAP sensor is normal when the value sensed by the MAP sensor is within a range from the minimum value to the maximum value.

3. The method of claim 1, wherein the step of determining whether the first and second TPSs are normal comprises a step of:
determining whether the first and second TPSs are normal when a difference between the values sensed by the first and second TPSs is less than a first reference value.

4. The method of claim 3, wherein the throttle opening degree is controlled using a value calculated by multiplying weighting factors by the sensed values of the first and second TPSs, respectively, at a predetermined ratio.

5. The method of claim 1, wherein the step of determining the normal TPS comprises a step of:
comparing a difference between the value sensed by the first TPS and the value sensed by the MAP sensor with a difference between the value sensed by the second TPS and the value sensed by the MAP sensor, and then determining a TPS, among the first and second TPSs, having a larger difference to be faulty.

6. The method of claim 5, further comprising a step of:
comparing a duration of the value sensed by the TPS which is determined to be faulty with a reference time period, and determining whether the duration exceeds the reference time period.
